(19) United States
(12) Patent Application Publication
(10) Pub. No.: US 2003/0150156 A1
(43) Pub. Date: Aug. 14, 2003

(54) Method and apparatus for eradicating soil borne pests

(76) Inventors: George Flagler, Parlier, CA (US); David Flagler, Selma, CA (US)

Correspondence Address: MARK D MILLER, KIMBLE, MACMICHAEL & UPTON, 5260 NORTH PALM AVENUE, SUITE 221, FRESNO, CA, 93704, US

(21) Appl. No.: 10/364,063

(22) Filed: Feb. 11, 2003

Related U.S. Application Data
(60) Provisional application No. 60/356,501, filed on Feb. 11, 2002.

(51) Int. Cl. A01G 7/04; A01C 1/00

(52) U.S. Cl. 47/1.3

(57) ABSTRACT

Disclosed is a method and apparatus for eradicate nematodes and other soil-borne organisms to a depth of up to several feet that uses specially-shaped electrically conductive metal shanks that are pulled through the soil profile by a tractor or other vehicle. The source of the electric charge is a generator and transformer connected to each conductive shank. Electric current passes through the soil between the shanks resulting in the electrocution of unwanted soil borne pests such as nematodes. Two rows of downwardly pointing generally vertical parallel shanks are provided, the leading row being a plurality of ripper shanks, and the trailing row being parallel electrically-conductive stinger shanks. The stinger shanks are wedge shaped from front to back to compress the soil between them so as to provide a more uniform electrical charge.

This application claims the benefit of U.S. provisional application No. 60/356,501 filed on Feb. 11, 2002.

### BACKGROUND OF THE INVENTION

1. Field of the Invention

The present invention relates to improving agricultural soils for planting, and more particularly to a method and apparatus that uses electricity for eradicating harmful soft nematodes and other soil-borne pests and organisms from soils prior to planting, thereby protecting cultivated farm crops from the deleterious effects caused by these pests.

2. Description of the Prior Art

It is important to eradicate soil borne pests from agricultural fields prior to planting. Without such eradication, nematodes and other organisms may affect, delay or even prevent the subsequently introduced plants from proper growth. The deeper the eradication treatment, the longer the head start given to the plants that are subsequently introduced. Conventional methods of pest eradication involve spraying or fumigating the soil using methyl bromide or other similar toxic chemicals. Application of such toxic materials has become highly restricted and/or illegal such that other alternatives for pre-planting eradication must be found.

A number of weed and pest eradication devices have been developed in the prior art that use electricity for eradication purposes. Known weed eradication devices rely upon touching the above-ground portions of growing weeds (leaves or stems) with electrically charged conductors for eradication purposes. Other devices use structures that penetrate the soil in order to eradicate soil borne pests such as nematodes and the like. However, existing soil electrification devices suffer from several drawbacks as described below.

U.S. Pat. No. 2,429,412 describes a system for applying electrical treatment to the soil in order to destroy pestiferous organic matter, as well as sterilize and cultivate the soil. This patent describes an apparatus that includes a generator and transformer connected to a box-like structure containing electrically conductive plates that penetrate the soil as the structure is pulled through a field. However, this device has no separate or leading soil ripper so that the horizontally oriented electrical plates located at the bottom of the box structure must themselves tear open the soil. The box-like structure containing the electrical conductors is small and provides very shallow soil treatment, and the top of the box structure must be kept in contact with the soil surface to provide proper conductivity which is difficult to maintain.

U.S. Pat. No. 2,588,561 applies electricity to the soil through a series of cultivation discs having conductive rings which are alternately charged in sequence. However, the discs do not provide deep soil treatment since less than half of their diameter penetrates the soil, and the conductive rings do not provide broad or complete electrical coverage especially since they only come into contact with loosened soil. Moreover, the conductive rings must constantly be replaced since they are part of the soil cultivation structure, and because they tend to deteriorate after prolonged contact with the soil. U.S. Pat. Nos. 4,758,318 and 6,237,278 suffer from similar drawbacks in that the conductive discs of these inventions are shallow and must themselves break the soil, leading to incomplete electrical coverage through contact with loosened soil.

It is therefore desirable to provide a durable, rugged and reliable soil pest eradication method and apparatus that is capable of providing broad and thorough eradication coverage deep into the soil.

### SUMMARY OF INVENTION

The method and apparatus of the present invention provides a way to eradicate nematodes and other soil-borne organisms to a depth of several feet by means of specially-shaped electrically conductive metal shanks that are pulled through the soil profile by a tractor or other means. The source of the electric charge is a generator and transformer connected to each conductive shank. Electric current passes through the soil between the shanks resulting in the electrocution of unwanted soil borne pests such as nematodes.

One embodiment of the invention includes an elongated toolbar supporting two rows of downwardly pointing generally vertical parallel shanks. The leading row includes a plurality of parallel ripper shanks, and the trailing row includes an identical number of parallel electrically-conductive stinger shanks, each stinger shank being located directly behind a corresponding ripper shank. The shanks of both rows are separated by appropriate spacing which may be adjusted in order to provide the desired electrical charge based on the quality, moisture and depth of the soil to be treated. The toolbar may be independently attachable or may be part of a larger trailer that is dragged behind a tractor or other vehicle, or it may be integrated into a self-propelled vehicle.

As the apparatus travels through a field, the rippers are pulled through the soil tearing open elongated rows. The depth of the rows is directly related to the length of the ripper shanks, and can range from several inches to several feet. The electrically conductive stinger shanks are pulled through the loosened soil behind the rippers. The generator and transformer supply electric current to the stinger so that the soil between the stingers is electrified, killing any soil borne pests located therein. The generator and transformer may be located on the toolbar, tractor, trailer, or any combination thereof. The amount of electricity may be varied according to the soil conditions, the spacing of the shanks, the degree of kill desired and the capacity of the generator and transformer. By passing this apparatus back and forth through a field before planting, pests may be eradicated from the entire field.

The profile of the stinger shanks is of particular importance to the successful operation of the present invention. First, the front and bottom surfaces of the stinger shanks are pointed, allowing them to pass through the soil more smoothly. In addition, the stinger shanks are tapered from front to rear so that their cross-section is more narrow in the front, and gradually becomes wider toward the rear. The tapering is more pronounced toward the bottom of the stinger shank. This causes the loosened soil between the stinger shanks to be compressed between the stinger shanks as they pass through the soil. This compaction causes more of the side surface areas of the shanks to come into contact with the soil, and greatly facilitates the transfer of electricity into and through the soil. The conductive portions of the stinger shanks are separated from the rest of the toolbar using conventional non-conductive materials.

In one aspect of the invention, the treatment of rows of planting berms between furrows is provided. In this aspect, the leading ripper shanks are eliminated, and the stinger shanks are incorporated into inverted U-shaped structures that correspond to the cross-sectional shape of the rows of planting berms. The stinger shanks are provided on the pairs of legs of the inverted U-shaped structures so as to provide an electrical charge across the berm as the stingers travel down the row. Multiple U-shaped structures are provided on a single toolbar to treat several rows in a single pass through a field.

It is therefore a primary object of the present invention to provide a method and apparatus for eradicating soil-borne pests such as nematodes through the use of electricity that is introduced into the soil.

It is also a primary object of the present invention to provide broad and complete electrification of soils up to a depth of several feet in order to eradicate soil-borne pests such as nematodes.

It is a further important object of the present invention to provide a durable, rugged and reliable apparatus for eradicating soil-borne pests by introducing electricity into the soil, the apparatus having structures for tearing open the soil that are separate from the electrically conductive structures which introduce the electricity into the soil.

It is also an important object of the present invention to provide an apparatus for eradicating soil-borne pests with electricity that uses specially shaped electrically conductive vertically oriented stinger shanks having pointed narrow leading edges and a tapered body of gradually increasing cross section for compression of soil between shanks for more complete electrification thereof.

Additional objects of the invention will be apparent from the detailed descriptions and the claims herein.

### BRIEF DESCRIPTION OF THE DRAWINGS

FIG. 1 is a perspective view of one embodiment of the present invention.

FIG. 2 is enlarged view along lines 2-2 of FIG. 1.

FIG. 3 is an enlarged perspective rear view of a single stinger shank along lines 3-3 of FIG. 1.

FIG. 4 is an enlarged perspective side view of the stinger shank of FIG. 3.

FIG. 5 is a cross-sectional view of a stinger shank along lines 5-5 of FIG. 1.

FIG. 6 is a diagrammatical representation of an embodiment having a series of seven stinger shanks.

FIG. 7 is a cross sectional view of a single stinger shank along line 7-7 of FIG. 4.

FIG. 8 is a side diagram view of the stinger shank of FIG. 7.

FIG. 9 is a side diagram view of an alternative embodiment of a single stinger shank of the invention.

FIG. 10 is a rear diagram view of the embodiment of FIG. 9.

FIG. 11 is a top diagram view of an alternative embodiment of a single stinger shank.

FIG. 12 is a front diagram view of the embodiment of FIG. 11.

### DETAILED DESCRIPTION OF A PREFERRED EMBODIMENT

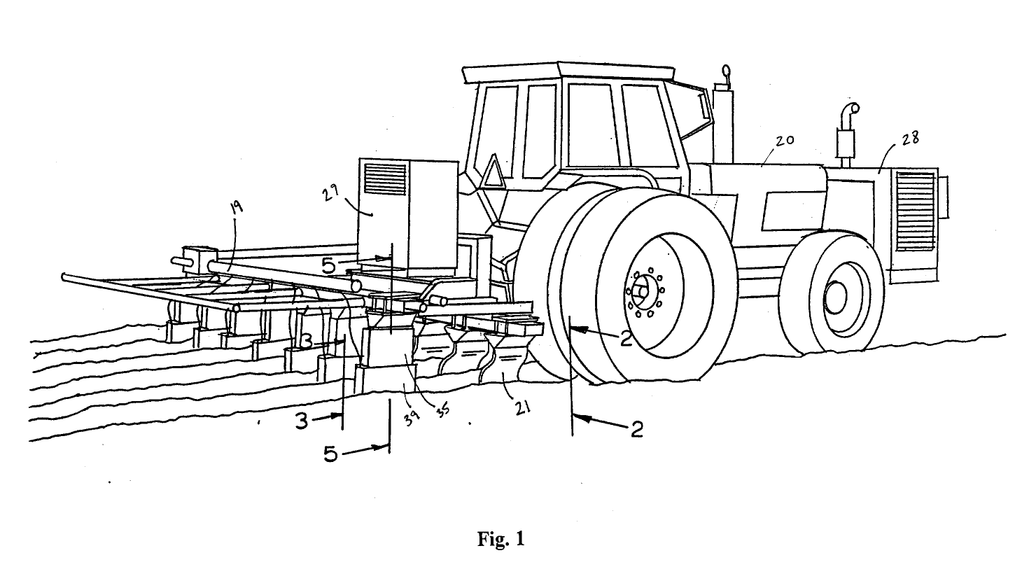

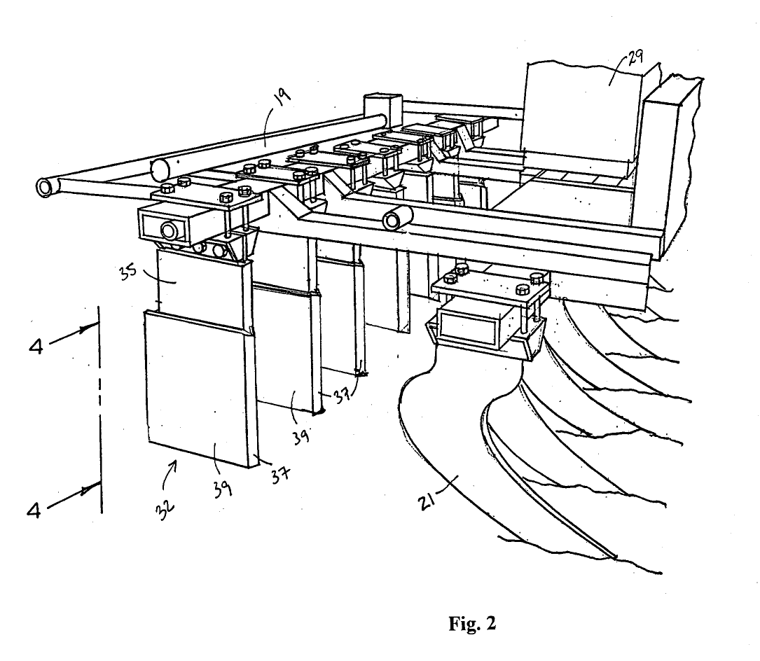

Referring to the drawings wherein like reference characters refer to the same or corresponding structures throughout the several views, and referring specifically to FIGS. 1 and 2, it is seen that the invention includes two rows of shanks adjustably attached to a tool bar 19. The shanks 21 of the leading row are ripper shanks designed to penetrate and loosen the soil. The shanks 32 of the trailing row are stinger shanks designed to impart electricity to the soil. Each of the stinger shanks 32 is mounted a short distance directly behind a corresponding ripper shank 21. This arrangement prolongs the life of the stinger shanks which do not themselves perform the function of ripping and loosening the soil. Any number of ripper shanks 21 may be provided together with up to an identical number of stinger shanks 32. Fewer stinger shanks may be employed than ripper shanks if desired or appropriate given the soil conditions.

An electrical generator 28 and a transformer 29 are provided for generating electrical power for use by the stinger shanks 32. The generator and transformer and may be mounted together with the shanks on the toolbar, on a trailer associated with the toolbar, on the tractor or other vehicle pulling the toolbar, or they may be mounted separately on any of these. Appropriate insulated wiring is used to deliver electrical power to the different exterior conductive surfaces 39, 40 of the stinger shanks in different phases as discussed more fully below.

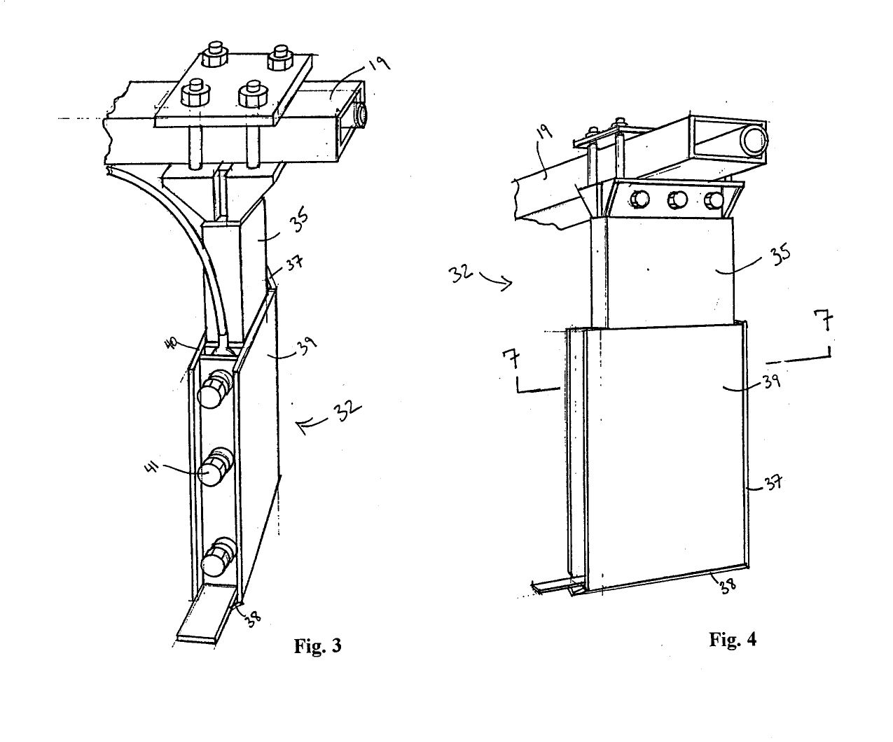

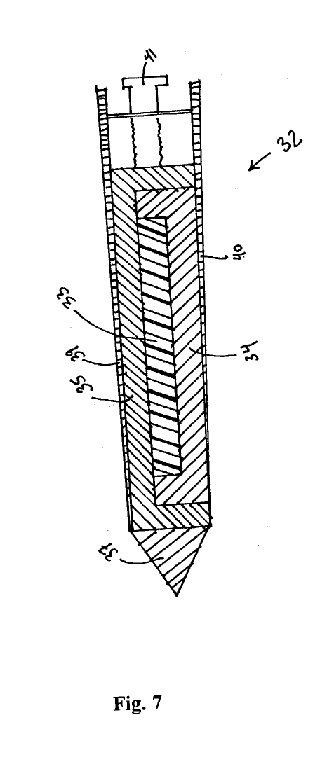

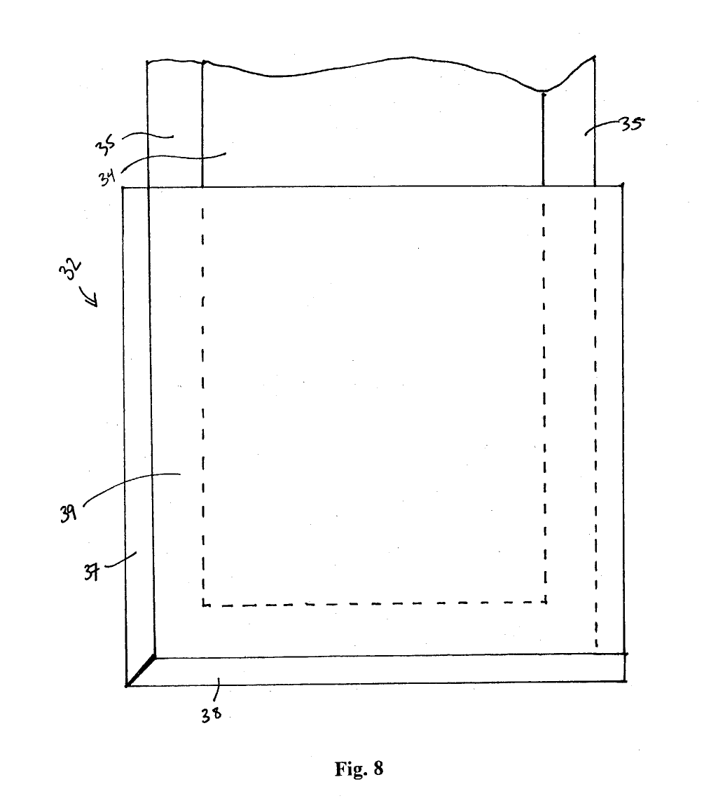

Referring to FIGS. 3-5 and 7-8, it is seen that each stinger shank 32 is attached to toolbar 19 using a central flange 33 preferably made of steel. Flange 33 is encapsulated inside two U-shaped insulated pieces 34 and 35 (see FIG. 7). Conductive metal surfaces 39 and 40 are provided on the outside of the insulated pieces 34 and 35. Surfaces 39 and 40 are attached to one of the outputs from the generator 28 and transformer 29. As can be seen in FIGS. 1 and 2, surfaces 39 and 40 come into direct contact with the soil to provide the sterilizing electricity. The leading edge 37 of each stinger shank 32 is tapered to a point so as to facilitate easy movement through the soil behind the ripper shanks 21. Similarly, the bottom edge 38 of each stinger shank is also tapered to a point. These pointed edges generally perform a knife blade or plow function as the stinger shank moves through the soil.

Referring specifically to FIG. 7, it is seen that the conductive sides 39, 40 of each stinger shank 32 are mounted such that the overall width of the shank increases from the leading edge 37 to the trailing edge. Thus, each stinger shank 32 forms a wedge that increases in size from front to rear. This wedge-shaped design allows for compacting the soil between the stinger shanks 32, thus increasing soil density as the stinger shank is pulled through the soil. This compaction increases conductivity of the electrical charge within the soil profile. The amount of width increase may be varied according to such things as the distance between stinger shanks, soil moisture, and other conditions. Adjustment may be accomplished using bolts 41.

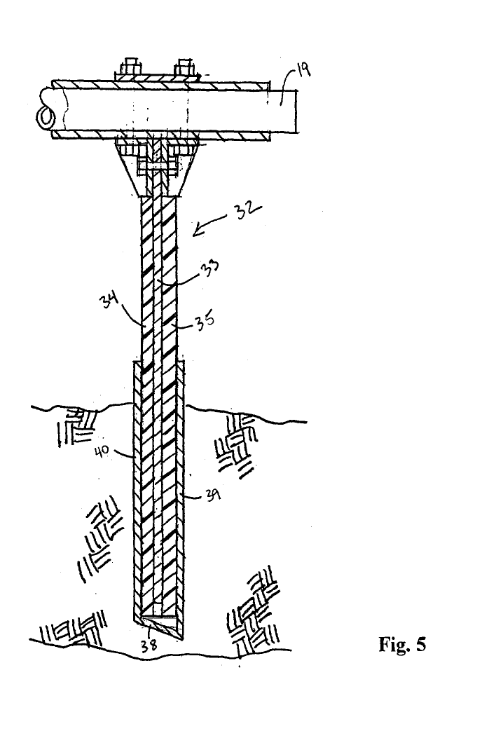

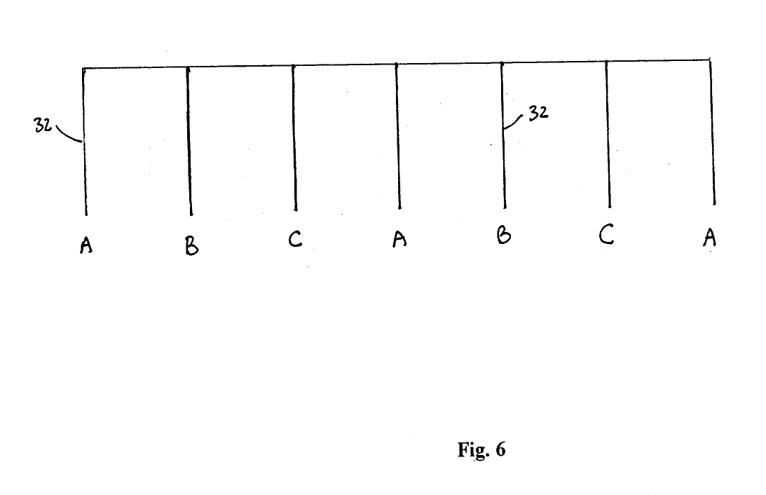

In the preferred embodiment, a standard 3-phase generator 29 is used, although any suitable generator having different phases may be employed with equal success. Using a 3-phase generator, at least 3+1=4 stinger shanks 32 are required for deployment next to each other so that each of the phases may complete an electrical circuit through the soil (A-B-C-A). Current flows from the generator between each of the three pairs of phases A-B, B-C, and C-A. Using the above 3+1 configuration, the generator may simultaneously provide current in all 3 phases, thereby continuously introducing electricity to the soil between each of the shanks. Additional shanks may be added using the 3-phase generator in the pattern 3+3+1: A-B-C-A-B-C-A (see diagram of FIG. 5 showing a 7-shank system). If a generator having two phases is used, then the shank pattern would be 2+1=3 (A-B-A), or 2+2+1 (A-B-A-B-A), etc. It is to be appreciated that the conductive panels 39, 40 on both sides of each stinger shank 32 receive a charge in the same electrical phase, and that only the soil between charged shanks will be electrified.

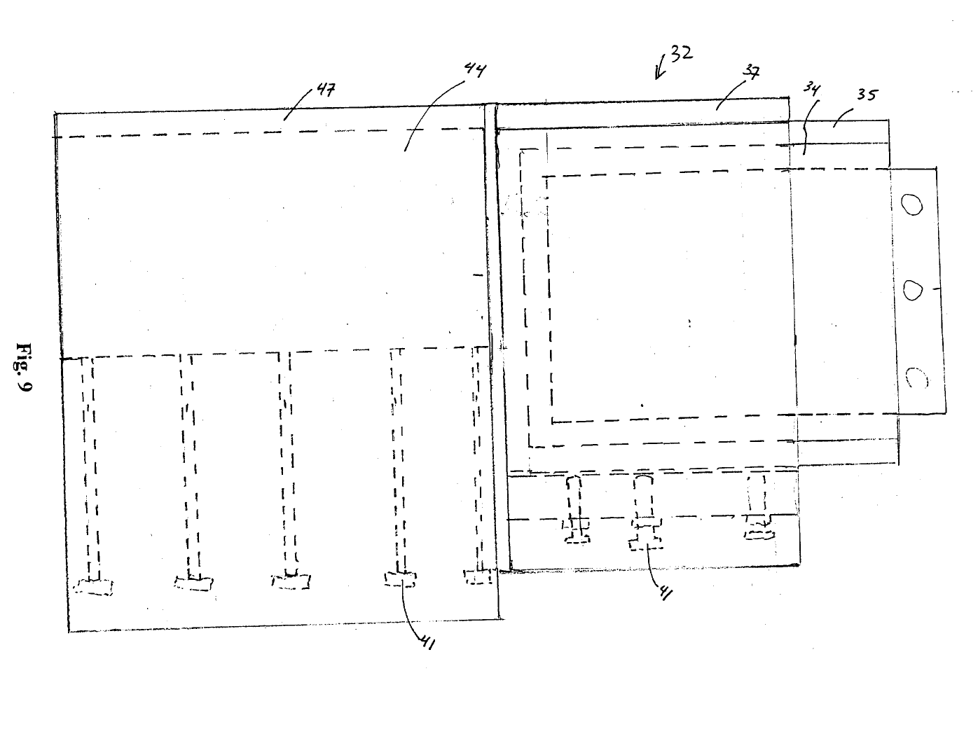

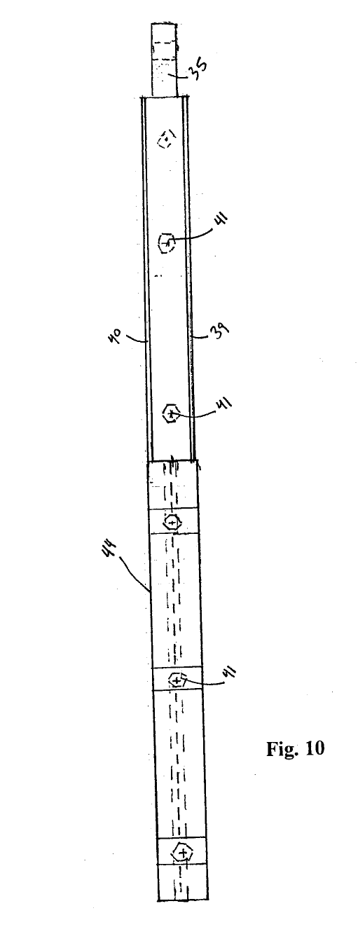

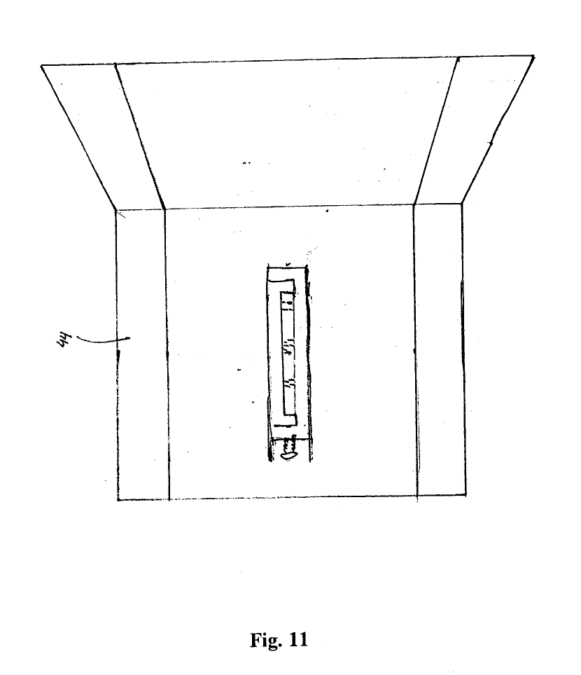

In an alternative embodiment illustrated in FIGS. 9 and 10, elongated stinger shanks are employed. The upper portion of these individual stinger shanks 32 is the same as described previously, however an additional conductive lower portion 42 is also provided that is attached to the bottom of the upper shank 32. The sides of lower portion 42 are conductive and carry the same charge/phase as the upper sides 39, 40. The lower portion may have a more pronounced wedge shape in comparison with upper shank 32, which may be adjusted according to soil conditions and the like using bolts 41. Longer ripper shanks 21 are also provided in this embodiment having approximately the same length (depth) as the elongated stinger shanks 32-42.

By way of example only, and without limiting the scope of the appended claims, in an embodiment of FIGS. 9 and 10, the entire shank 42 may be 36 inches tall, although other dimensions may be used. The top portion 32 (approximately 18 inches) of this elongated shank differs in design from the bottom portion 42. The top portion 32 viewed from a front profile may have a width of 3 inches at the leading edge to 3.5 inches at the trailing edge illustrated in FIG. 7. The bottom portion 42 (in this case, the other 18 inches) of the stinger shank viewed from a front profile may have a width that varies from about 3 inches at the leading edge to a range of between about 5 to about 8 inches at the trailing edge. The width is adjustable using adjustment bolts 41 which act as wedges.

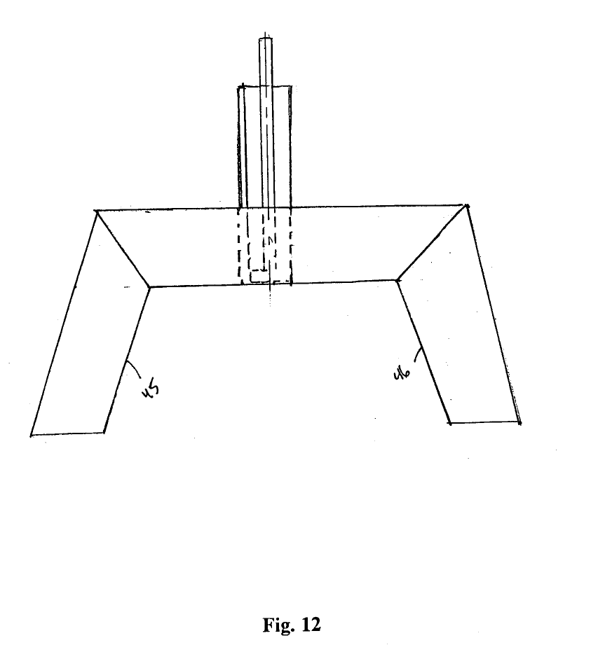

Another alternative embodiment is illustrated in FIGS. 11 and 12. This embodiment provides a plurality of above-ground mound or berm shaping stingers 44. Each of stingers 44 is shaped in the form of an inverted U which is designed to follow the contour of an above-ground berm of soil forming a row into which crops will be planted. The insides of each of the legs of the inverted U are made of electrically conductive material, and these surfaces 45, 46 touch the soil on the sides of the berm such that a charge is provided across the berm as the stinger passes across it. This provides for sterilizing the surface area of a berm prior to planting row crops. A plurality of the inverted U-shaped structures may be provided to treat several rows in a single pass.

The treatment of soil using the method and apparatus of the present invention should be carried out prior to the planting of crops. The electrical energy could potentially cause damage to existing plants and root systems. Because the mode of action for to control pests is electricity, there are virtually no adverse effects on the soil. There is the possibility that soil microbes will need to be replenished due to killing of naturally occurring organisms while treating for nematodes. The treatment of soil using the method and apparatus of the present invention prefers that the soil be moist in order to better conduct electricity. Thus, it is preferred that the treatment take place within a reasonably short time after a rain or after irrigation. The more moisture in the soil, the more effective the treatment will be.

While any suitable dimensions may be used, as another example, and without limiting the scope of the appended claims, the flange 33 shown in FIG. 7 may be constructed of 1 inch by 10 inch cold rolled steel encased in two C-shaped pieces 34, 35 of Ultra High Molecular Weight (UHMW) plastic for insulation purposes. The dimensions of UHMW plastic that encases the stinger shank may be, for example, about 2 inches thick by about 31.5 inches wide. The leading edge 37 of each stinger shank may be constructed, for example, at about a 45 degree angle, although any suitable angle may be used. Leading edge may be made of hard-faced, cold rolled steel. The bottom edge 38 is also angled. Silicone sealant may be applied at the top on the seam between the UHMW plastic 34, 35 and the metal flange 33 of the stinger to prevent moisture access to the activated plates 39, 40 and to prevent shorting between the stinger shank 33 and tool bar 19 attachment. The bottom of the stinger shank may be provided with removable drains to prevent moisture accumulation.

Any appropriate number of ripper and stinger shanks may be employed, having a depth of several inches to several feet. By way of example only, and without limiting the scope of claims, the embodiment shown in FIGS. 1 and 2 includes two parallel rows of seven ripper shanks 21 on the toolbar 19. With a 7-ripper shank design, the treated soil zone may be up to 12 feet wide and, for example, 2 feet deep with each pass through a field. This particular embodiment shows a toolbar that is pulled through the soil profile by a tractor. On the front of the tractor is mounted a diesel-powered generator 28, and mounted on the toolbar are the transformer 29, circuitry and ripper shanks 21. The toolbar has two rows of shanks. The first row of 7 diabolic ripper shanks may be, for example, approximately 1.25 inches wide by 33 inches deep. This row of ripper shanks digs a channel approximately 24 inches deep in the soil for the second row of stinger shanks to pass through, and also loosens and opens the soil profile. In this example, about 36 inches behind the first row of 7 ripper shanks 21 is the second row of 7 stinger shanks 32. These stingers 32 are connected to a generator and transformer, the generator having, for example, a 480 volt output which is run through a multiplier transformer of, for example, 9.5 to 1, to produce 4160 volts at a maximum output of 200 amps at the stinger shanks. The transformer is wired to the 7 individual stinger shanks using high voltage wire. All electric cables are encased in PVC plastic pipe between the generator, transformer, junction box and shanks. In the embodiment of FIGS. 1 and 2, each individual stinger shank 32 is wedge-shaped and tapered, for example, from a width of about 3 inches at the leading edge to about 3.5 inches at the trailing edge, as shown in FIG. 7. Other dimensions may be used depending on the soil and conditions, so long as the width increases from front to rear.

In use, once the tractor 20 is operating and positioned in the field, the generator 28 is started and the shanks 21 dropped into the soil profile. The generator 29 and stinger shanks 32 are activated from an operator control panel in the cab. The generator is brought up to operating capacity and is activated by a magnetic switch wired to the transformer. Once at operating voltage, the tractor begins moving through field at a slow pace, approximately 1 to 1.5 mph depending on soil conditions. The shanks penetrate the soil, and electrical output flows to the stinger shanks. This output may be adjusted according to soil conditions and conductivity of the soil. Electricity emits from each stinger shank in a plume radiating outward from the outer shanks and below the bottom of each stinger shank for several inches. Between each stinger shank, the electric charge plume is continuous.

Set forth below is an example set of particulars for a typical embodiment of the invention:

Toolbar total weight: 7500 pounds.

Generator: 5500 pounds and 300 horsepower diesel motor.

Towing tractor requirement: 200 horsepower, 4 wheel-drive.

Toolbar width: 12.0 feet.

Ripper shank/stinger shank spacing:

20.5 inches between centers;

17.0 inches spacing between shank base.

The invention may not be applicable in soils with high organic matter such as peat moss because of the propensity for organic matter to catch fire. During field development trials, small wood residues from trees tended to spark and larger wood products caught between stinger shanks would sometimes ignite.

It is to be understood that variations and modifications of the present invention may be made without departing from the scope thereof. It is also to be understood that the present invention is not to be limited by the specific embodiments disclosed herein, but only in accordance with the appended claims when read in light of the foregoing specification.

What is claimed is:

1. An apparatus for introducing electricity into soil to eradicate pests comprising:
a. a plurality of downwardly pointing ripper shanks attached in parallel to the leading end a support member;
b. a second plurality of downwardly disposed stinger shanks attached to the trailing end of said support member, each of said stinger shanks being aligned with one of said ripper shanks and having at least one electrically conductive exterior surface;
c. a generator for generating an electrical current to be supplied to said stinger shanks; and
d. a transformer in communication with said generator and said stinger shanks for converting the electrical current supplied to said stinger shanks.

2. The apparatus of claim 1 wherein each of said stinger shanks has a generally flat cross section, a pointed leading edge, and a pointed bottom edge.

3. The apparatus of claim 2 wherein each of said stinger shanks has a wedge-shaped cross section that increases in width from the leading to the trailing edge of each such shank.

4. The apparatus of claim 3 wherein the width of each of said stinger shanks is adjustable.

5. The apparatus of claim 4 wherein each of said ripper shanks and each of said stinger shanks extends into the soil to a depth of at least eighteen inches.

6. The apparatus of claim 4 wherein each of said ripper shanks and each of said stinger shanks extends into the soil to a depth of at least three feet.

7. The apparatus of claim 4 wherein said generator provides electricity in three phases A, B and C, and four stinger shanks are provided and supplied electricity in the phase pattern A-B-C-A.

8. The apparatus of claim 4 wherein said generator provides electricity in three phases A, B and C, and seven stinger shanks are provided and supplied electricity in the phase pattern A-B-C-A-B-C-A.

9. The apparatus of claim 1 wherein each of said stinger shanks is generally in the form of an inverted U having two downwardly disposed legs, and wherein the inside of each of said legs has an electrically conductive surface.

10. A method for eradicating soil-borne pests comprising the steps of:
a. determining the moisture content of the soil to be treated;
b. determining the depth of the soil to be treated;
c. determining the length of ripper shanks to be pulled through said soil to loosen the soil to the pre-determined depth, and adjusting a set of ripper shanks attached to a cross member to such length;
d. determining the spacing between electrically conductive wedge-shaped stinger shanks to be pulled through the soil behind said ripper shanks in order to electrically treat said soil, and adjusting the positions of said ripper shanks and corresponding stinger shanks attached to said cross member according to said spacing;
e. adjusting the width of said wedge-shaped stinger shanks according to the soil conditions;
f. electrically activating said stinger shanks; and
g. pulling said cross member carrying said ripper shanks and stinger shanks through the soil to be treated.
